(19) United States
(12) Patent Application Publication
(10) Pub. No.: US 2017/0353559 A1
(43) Pub. Date: Dec. 7, 2017

(54) SYSTEM AND METHOD FOR CONTROLLING VEHICLE BASED ON INSTANT MESSAGING

(71) Applicant: ZENOME INC., Seongnam-si (KR)

(72) Inventors: YongHo SEO, Yongin-si (KR); HyeRim Park, Yongin-si (KR)

(21) Appl. No.: 15/612,018

(22) Filed: Jun. 2, 2017

(30) Foreign Application Priority Data
Jun. 2, 2016 (KR) 10-2016-0068768

(51) Int. Cl. H04L 29/08; G06F 17/27; G05D 1/00

(52) U.S. Cl. CPC H04L 67/125; G05D 1/0011; G06F 17/2785

(57) ABSTRACT

A system and method for controlling a vehicle based on instant messaging enables a user to control his or her vehicle in such a way as to perform messaging with the vehicle through an instant messenger. The method includes creating, by a vehicle control system based on instant messaging, a vehicle account corresponding to a vehicle of a user in a specific instant messaging service, performing, by the vehicle control system, control so that the vehicle account is registered with an account of the user previously created in the instant messaging service as a counterpart for conversation, obtaining, by the vehicle control system, an instant message transmitted from the account of the user to the vehicle account through the instant messaging service, and performing, by the vehicle control system, control so that the vehicle performs a control operation corresponding to the instant message.

### CROSS REFERENCE TO RELATED APPLICATION

This application claims priority from and the benefit of Korean Patent Application No. 10-2016-0068768, filed on Jun. 2, 2016, which is hereby incorporated by reference for all purposes as if fully set forth herein.

### BACKGROUND

### Field

Exemplary embodiments relate to a system and method for controlling a vehicle based on instant messaging, more particularly, to a system and method for controlling a vehicle based on instant messaging, which enable a user to control his or her vehicle in such a way as to perform messaging with the vehicle through an instant messenger.

### Discussion of the Background

With the recent development of information communication technology, various types of information providing services have been applied for providing a plurality of subscribers with information about various fields through the medium of a wired/wireless communication network. In the case of information providing services, for example, convenience devices using telematics and a portable terminal are provided to a vehicle. A representative example may include a remote control system capable of checking various devices applied to the vehicle. The remote control system provides a service through wireless communication between a server located at a remote place, the telematics terminal of a vehicle, and a portable terminal (e.g., a terminal for remote control or a smart phone) owned by a driver. The remote control system provides a service capable of checking an overall state of a vehicle, such as the current servicing state of the vehicle, the starting locking of the vehicle, the speed deceleration of the vehicle, remote air-conditioning control, remote door-lock control and robbery detection. That is, a user may request remote control from a telematics server through a portable terminal. The requested remote control operation is performed through the telematics server located at a remote place and a telematics terminal connected to the telematics server through wireless communication. The telematics terminal mounted on the vehicle can control the function of the vehicle through a command transmitted by the telematics server.

The above information disclosed in this Background section is only for enhancement of understanding of the background of the inventive concepts, and, therefore, it may contain information that does not form the prior art that is already known in this country to a person of ordinary skill in the art.

### SUMMARY

An exemplary embodiment provides a vehicle control system based on instant messaging, including an account creation step of creating, by a vehicle control system based on instant messaging, a vehicle account corresponding to a vehicle of a user in a specific instant messaging service, a registration step of performing, by the vehicle control system based on instant messaging, control so that the vehicle account is registered with an account of the user previously created in the instant messaging service as a counterpart for conversation, an acquisition step of obtaining, by the vehicle control system based on instant messaging, an instant message transmitted from the account of the user to the vehicle account through the instant messaging service, and a control step of performing, by the vehicle control system based on instant messaging, control so that the vehicle performs a control operation corresponding to the instant message.

In an exemplary embodiment, the acquisition step may include the steps of generating a menu message including a plurality of menus respectively corresponding to a plurality of vehicle control commands for controlling the vehicle, performing control so that the menu message is transmitted from the vehicle account to the account of the user, and obtaining the instant message transmitted from the account of the user to the vehicle account.

In an exemplary embodiment, the acquisition step may further include the steps of obtaining information about the vehicle and specifying a plurality of vehicle control commands for controlling the vehicle based on the information of the vehicle.

In an exemplary embodiment, the step of performing control so that the menu message is transmitted from the vehicle account to the account of the user may include requesting a specific instant messaging service providing system which provides the instant messaging service to send the menu message. The step of obtaining the instant message transmitted from the account of the user to the vehicle account may include receiving the instant message from the instant messaging service providing system.

In an exemplary embodiment, the control step may include the steps of specifying a control operation to be performed by the vehicle based on the obtained instant message and controlling the vehicle so that the vehicle performs the specified control operation.

In an exemplary embodiment, the step of specifying the control operation to be performed by the vehicle based on the obtained instant message may include specifying the control operation to be performed by the vehicle by performing natural language analysis of the obtained instant message.

In an exemplary embodiment, the step of controlling the vehicle so that the vehicle performs the specified control operation may include sending a control request for enabling the vehicle to perform the control operation to a specific telematics server which performs a function for controlling the vehicle.

Exemplary embodiments also provide a computer program installed on a data processing unit and stored in a computer-readable recording medium in order to perform the method.

Exemplary embodiments further provide a vehicle control system based on instant messaging, including a processor and memory configured to store a computer program executed by the processor, wherein when the computer program is executed by the processor, the computer program enables the vehicle control system based on instant messaging to perform the aforementioned method.

Exemplary embodiments also provide a vehicle control system based on instant messaging, including an account creation module configured to create a vehicle account corresponding to a vehicle of a user in a specific instant messaging service, a registration module configured to perform control so that the vehicle account is registered with an account of the user previously created in the instant messaging service as a counterpart for conversation, an acquisition module configured to obtain an instant message transmitted from the account of the user to the vehicle account through the instant messaging service, and a control module configured to control the vehicle so that the vehicle performs a control operation corresponding to the instant message.

In an embodiment, the acquisition module may generate a menu message including a plurality of menus respectively corresponding to a plurality of vehicle control commands for controlling the vehicle, may perform control so that the menu message is transmitted from the vehicle account to the account of the user, and may obtain the instant message transmitted from the account of the user to the vehicle account.

In an exemplary embodiment, the acquisition module may obtain information about the vehicle and specify a plurality of vehicle control commands for controlling the vehicle based on the information of the vehicle.

In an exemplary embodiment, the acquisition module may request a specific instant messaging service providing system which provides the instant messaging service to send the menu message in order to perform control so that the menu message is transmitted from the vehicle account to the account of the user, and may receive the instant message from the instant messaging service providing system in order to obtain the instant message transmitted from the account of the user to the vehicle account.

In an exemplary embodiment, the control module may specify a control operation to be performed by the vehicle based on the obtained instant message and perform control so that the vehicle performs the specified control operation.

In an exemplary embodiment, the control module may specify the control operation to be performed by the vehicle by performing natural language analysis of the obtained instant message in order to specify the control operation to be performed by the vehicle based on the obtained instant message.

In an exemplary embodiment, the control module may send a control request for enabling the vehicle to perform the control operation to a specific telematics server which performs a function for controlling the vehicle in order to control the vehicle so that the vehicle performs the specified control operation.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concepts, and are incorporated in and constitute a part of this specification, illustrate exemplary embodiments of the inventive concepts, and, together with the description, serve to explain principles of the inventive concepts.

FIG. 1 is a diagram for schematically illustrating a system for controlling a vehicle based on instant messaging according to an exemplary embodiment.

FIG. 2 is a block diagram showing a schematic configuration of the system for controlling a vehicle according to an exemplary embodiment.

FIG. 3 is a diagram showing an example of a screen of a messenger application installed on a user terminal.

FIGS. 4 and 5 are flowcharts illustrating a method for controlling a vehicle according to an exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Furthermore, in this specification, if one element “sends” data to the other element, this means that one element may directly send the data to the other element or may send the data to the other element through at least another element. In contrast, if one element “directly sends” data to the other element, this means that the data is transmitted from one element to the other element without the intervention of another element.

Hereinafter, the present invention is described in detail based on embodiments of the present invention with reference to the accompanying drawings. The same reference numerals proposed in the drawings denote the same member.

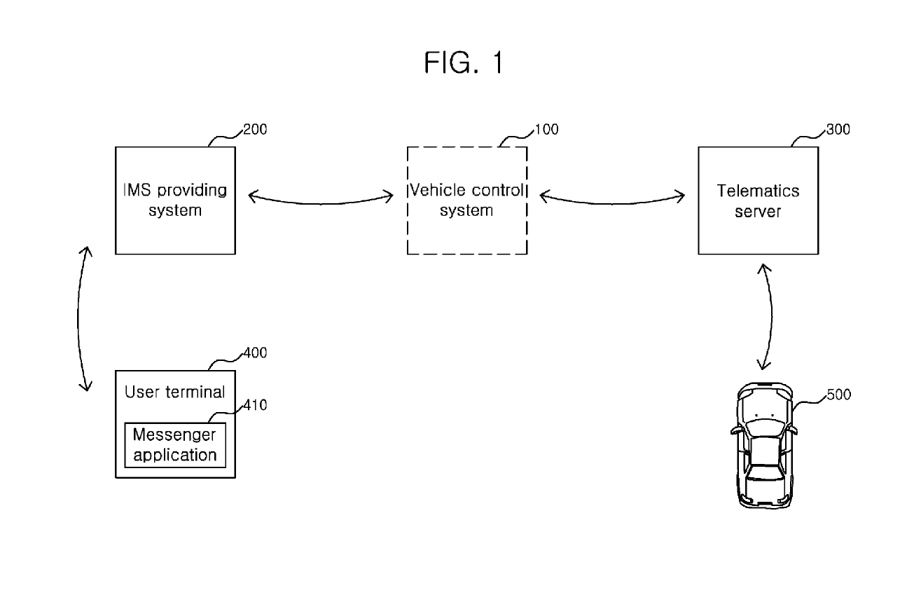

FIG. 1 is a diagram for schematically illustrating a system for controlling a vehicle (hereinafter referred to as a “vehicle control system”) based on instant messaging according to an embodiment of the present invention. As shown in FIG. 1, the vehicle control system 100 may be provided in order to implement a method for controlling a vehicle (hereinafter referred to as a “vehicle control method”) based on instant messaging according to the technical spirit of the present invention.

As shown in FIG. 1, the vehicle control system 100 is connected to a specific instant messaging service (IMS) providing system 200 through wired/wireless communication and may send or receive a variety of types of information, data, signals and/or messages which is necessary to implement the technical spirit of the present invention.

The IMS providing system 200 may be a system for providing an IMS. The IMS may mean a service through which users can exchange messages over a wired/wireless communication network or through the Internet. The IMS may include an IP protocol-based messaging service and an SS7 protocol-based messaging service, such as SMS/MMS/LMS.

A user who has joined the IMS may create his or her account, may register the account of a counterpart with which the user wants to talk with the created account, and may exchange messages with the counterpart. Messages which may be exchanged in the IMS are not limited to text, but may include multimedia content, such as an image, music and a moving image, or emoticon.

The IMS providing system 200 may provide an IMS in an additional service form of a different Internet/online service. For example, the IMS may be a messaging service additionally provided by a social networking service (e.g., Facebook).

When a message is transmitted from an account registered as a counterpart for conversation with a user to the account of the user, the IMS providing system 200 may send the message to a messenger application 410 installed on a user terminal 400. The messenger application may display the message. The messenger application 410 may be a computer program which performs functions for adding/deleting a counterpart for conversation, creating a chat room, displaying a received instant message, and sending an instant message to a counterpart for conversation.

The vehicle control system 100 may dynamically configure a service screen and/or function for providing telematics service and distribute the service screen and/or function to a user. Furthermore, the vehicle control system 100 may create an account necessary to provide telematics service through instant messaging and perform control so that the created account is added as a friend of a user. Furthermore, the vehicle control system 100 may analyze/understand the context of a message transmitted by a user through chatting and dynamically configure a service screen and/or a function based on the context.

In a broad sense, Chatbots may refer to a function performed by the vehicle control system 100 or a service provided from the vehicle control system 100 to a user. In a narrow sense, Chatbots may refer to an account through which a conversation with a user is performed through an IMS in order to provide the user with such a function.

The vehicle control system 100 may create a vehicle account, corresponding to a vehicle 500, on the IMS, and may perform control so that the created vehicle account is registered with the account of a user, corresponding to the user terminal 400, as a counterpart for conversation. Furthermore, the vehicle control system 100 may perform control so that a menu message is transmitted from the vehicle account to the account of the user and may obtain an instant message transmitted from the account of the user to the vehicle account. An application programming interface (API) may have been previously defined in the IMS providing system 200. The vehicle control system 100 may request the creation of an account, the registration of a counterpart for conversation, and the exchange of messages between the vehicle account and the user account from the IMS providing system 200 through the predefined API.

Meanwhile, in some embodiments, the vehicle control system 100 may be connected to a specific telematics server 300 through wired/wireless communication, and may send or receive a variety of types of information, data, signals and/or messages necessary to implement the technical spirit of the present invention.

In an embodiment, the vehicle control system 100 may interact with the vehicle 500 of the user through the telematics server 300.

The telematics server 300 can provide telematics service for providing the user of the vehicle with a variety of types of information (e.g., traffic guidance and emergency rescue) using location information and a mobile communication network (or a wireless communication network), diagnosing the state of the vehicle or controlling the functions of the vehicle (e.g., control the door opening or shutting, starting, lighting or air-conditioning apparatus of the vehicle). To this end, a telematics terminal (not shown) may be mounted on the vehicle 500. The telematics server 300 may perform wireless communication with the telematics terminal mounted on the vehicle.

FIG. 1 shows an embodiment in which the vehicle control system 100 is physically separated from the IMS providing system 200 and the telematics server 300 and is implemented in such a way as to communicate with the IMS providing system 200 and the telematics server 300 through wired/wireless communication. In some embodiments, the vehicle control system 100 may be implemented as part of the IMS providing system 200 or the telematics server 300.

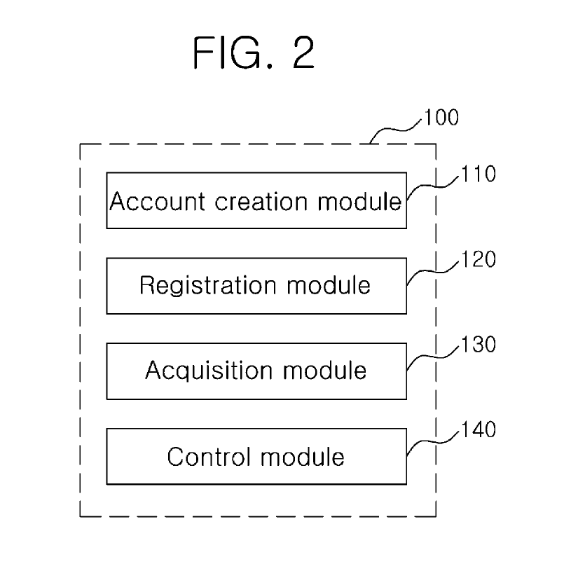

FIG. 2 is a block diagram showing a schematic configuration of the vehicle control system 100 according to an embodiment of the present invention.

Referring to FIG. 2, the vehicle control system 100 may include an account creation module 110, a registration module 120, an acquisition module 130 and a control module 140. In an embodiment of the present invention, some of the elements of FIG. 2 may not correspond to an element essentially required for an implementation of the present invention. Furthermore, in some embodiments, the vehicle control system 100 may include elements greater or less than the aforementioned elements.

The control module 140 may control the functions and/or resources of other elements (e.g., the account creation module 110, the registration module 120 and the acquisition module 130) included in the vehicle control system 100.

The account creation module 110 may create a vehicle account, corresponding to the vehicle 500 of a user, in a specific IMS provided by the instant messenger service providing system 200. The registration module 120 may perform control so that the vehicle account is registered with the account of the user previously created on the IMS as a counterpart for conversation.

Prior to the process of registering the counterpart for conversation, the registration module 120 may perform an authentication process on the user. The authentication process may be a specific process of confirming whether a user corresponding to the user terminal 400 is a legitimate user. For example, the registration module 120 may question about a registration number/password/login ID which have been previously issued to the user by the user terminal 400. In addition, the authentication process performed by the registration module 120 may be various.

The account creation module 110 and/or the registration module 120 may request the creation of an account and/or the registration of a counterpart for conversation from the IMS providing system 200 through a predefined API. In response to the request, the IMS providing system 200 may perform the creation of a vehicle account and/or the registration of the counterpart for conversation.

The acquisition module 130 may generate a menu message including a plurality of menus respectively corresponding to a plurality of vehicle control commands for controlling the vehicle, and may perform control so that the menu message is transmitted from the vehicle account to the account of the user.

The menu message is a message transmitted from the account of the vehicle to the account of the user under the control of the acquisition module 130. The menu message may play the role of guiding various commands which may be issued by the user. The menu message may include a plurality of menus respectively corresponding to vehicle control commands.

The menu message transmitted from the account of the vehicle to the account of the user may be transmitted to the user terminal 400 by the IMS providing system 200. Accordingly, the messenger application 410 installed on the user terminal 400 may display the menu message.

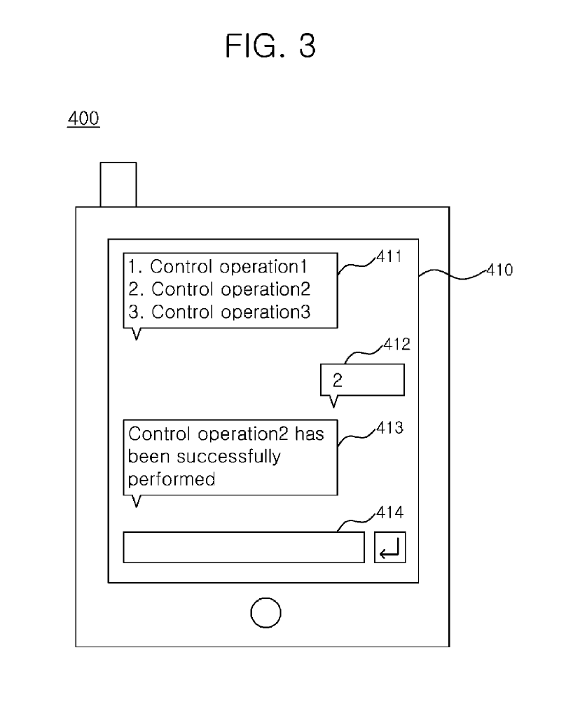

FIG. 3 is a diagram showing an example of a screen of the messenger application 410 installed on the user terminal 400.

When a menu message 411 is transmitted from the account of the vehicle to the account of the user by the acquisition module 130, the menu message 411 may be displayed in the messenger application 410. In the example of FIG. 3, the menu message 411 may include menus (1. Control operation1, 2. Control operation2 and 3. Control operation3) respectively corresponding to three control operations. FIG. 3 illustrates an example in which the menu message is text, for convenience sake. In some implementation examples, however, the menu message may include emoticon or multimedia content, such as an image/moving image/music.

Furthermore, the menu message may have a hierarchical structure. That is, one menu (or submenu) may include one or more submenus. In this case, when a user selects a corresponding menu, the acquisition module 130 may perform control so that a menu message including a submenu corresponding to the selected menu is transmitted from the account of the vehicle to the account of the user.

The menu message may be dynamically specified depending on the situation of the vehicle or other situations. In an embodiment, the acquisition module 130 may obtain information about the vehicle and specify a plurality of vehicle control commands for controlling the vehicle based on the information of the vehicle. The information about the vehicle may include the type or model, manufacturer and/or current state of the vehicle. For example, a function capable of being performed by a corresponding vehicle may be limited depending on the type or model of the vehicle. Accordingly, the acquisition module 130 may specify a command, corresponding to a function supported by the vehicle 500, as the plurality of vehicle control commands based on the information about the vehicle 500.

Furthermore, the acquisition module 130 may include an icon or image indicative of the type or model and current state of the vehicle, etc. in the menu message.

The acquisition module 130 may request the transmission of the menu message from the IMS providing system 200 so that the menu message is transmitted from the vehicle account to the account of the user.

The acquisition module 130 may obtain the instant message transmitted from the account of the user to the vehicle account through the IMS.

The user of the vehicle may input the instant message through his or her user terminal 400. The input instant message may be transmitted to the account of the vehicle by the IMS providing system 200. Accordingly, the acquisition module 130 may receive the instant message transmitted to the account of the vehicle from the IMS providing system 200.

For example, as shown in FIG. 3, after the menu message 411 is displayed in the messenger application 410, the user may send the instant message to the vehicle account through an input UI 414. FIG. 3 shows an example in which 2 was entered for the purpose of selecting “2. Control operation2.” Accordingly, as will be described later, the vehicle control system 100 may perform vehicle control corresponding to “2. Control operation2,” and may perform control so that a corresponding response 413 is transmitted from the vehicle account to the user account.

Referring back to FIG. 2, the control module 140 may control the vehicle 500 so that the vehicle performs a control operation corresponding to the instant message. In an embodiment, in order to control the vehicle so that it performs a specified control operation, the control module 140 may send a control request for enabling the vehicle 500 to perform the control operation to the telematics server 300 which performs a function for controlling the vehicle. Accordingly, the telematics server 300 may perform control for enabling the vehicle 500 to perform the control operation using various known methods.

The control module 140 may specify a control operation to be performed by the vehicle based on the obtained instant message, and may perform control so that the vehicle performs the specified control operation. For example, in order to specify a control operation to be performed by the vehicle based on the obtained instant message, the control module 140 may specify the control operation to be performed by the vehicle by performing natural language analysis of the obtained instant message.

As described above, the vehicle control system 100 according to an embodiment of the present invention can provide a technical spirit, which enables an interaction with a user to be performed and enables the user to control a vehicle through a widely used instant messaging service and messenger application without a need to develop a separate-dedicated application for controlling the vehicle or to install the separate-dedicated application on the user terminal 400. Accordingly, the vehicle control system 100 has advantages in that it can reduce resources for the development of an application and can handle the addition or change of a vehicle control operation with low cost if the vehicle control operation is added or changed. Furthermore, there is an advantage in that convenience can be improved because a user can control his or her vehicle through the UI of a messenger application that is frequently used by the user.

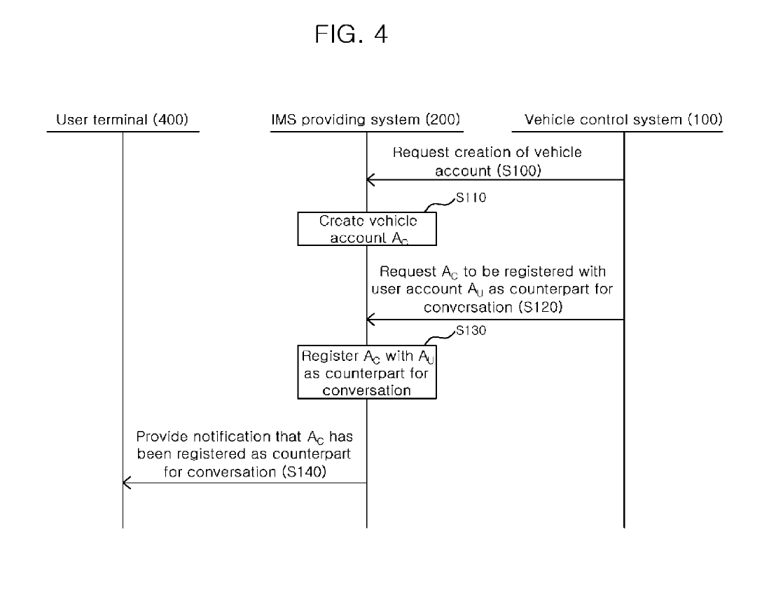

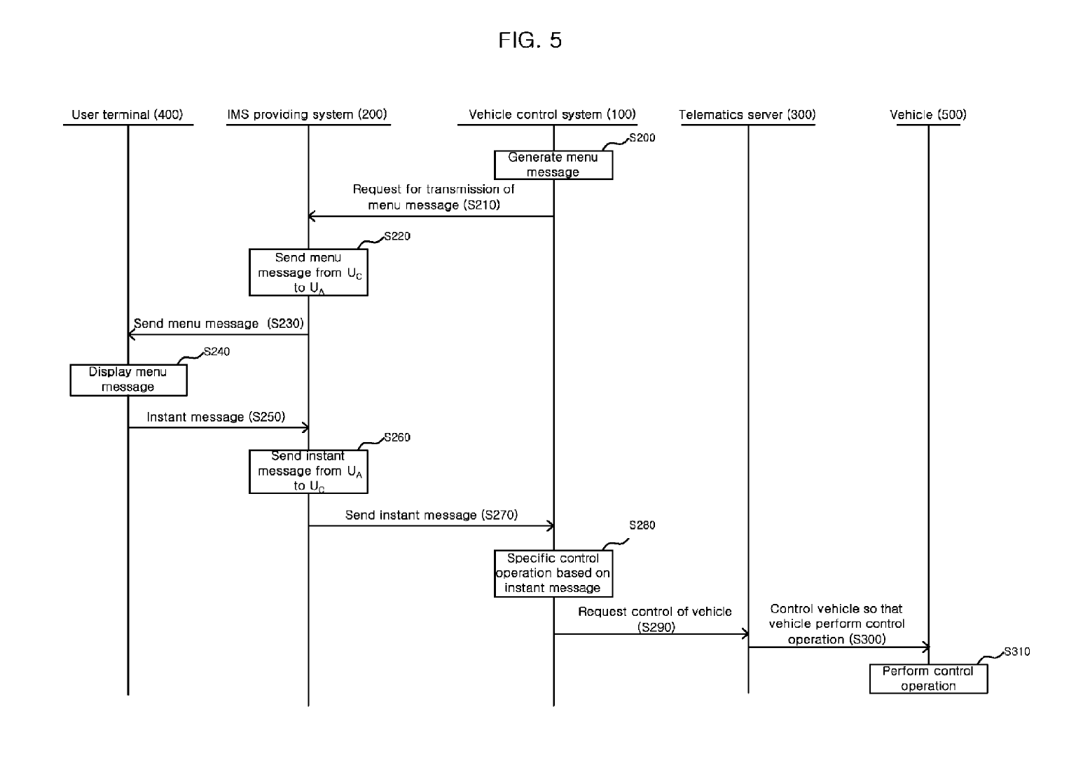

FIGS. 4 and 5 are flowcharts illustrating a method for controlling a vehicle according to an embodiment of the present invention. FIG. 4 shows a process of creating an account and registering a counterpart for conversation, which needs to be performed before a user controls a vehicle. FIG. 5 shows a process of controlling, by the user, the vehicle through an IMS.

Referring to FIG. 4, first, in order to create a vehicle account, corresponding to the vehicle of a user, on an IMS, the vehicle control system 100 may request the creation of the vehicle account from the IMS providing system 200 (S100). In response to the request, the IMS providing system 200 may create the account Ac of the vehicle on the IMS (S110).

Furthermore, the vehicle control system 100 may send a request for registering the account Ac of the vehicle with the account Au of the user of the vehicle as a counterpart for conversation (S120). In response to the request, the IMS providing system 200 may register the account Ac of the vehicle as the counterpart for conversation of the account Au of the user (S130). In this process, the IMS providing system 200 may previously perform a process of confirming the user.

When the account Ac of the vehicle is registered as the counterpart for conversation of the account Au of the user, the IMS providing system 200 may notify the user terminal 400 of the registration (S140). The account Ac of the vehicle may be displayed in the messenger application 410 installed on the user terminal 400 as one of counterparts for conversation.

Referring to FIG. 5, the vehicle control system 100 may generate a menu message including a plurality of menus respectively corresponding to a plurality of vehicle control commands for controlling the vehicle 500 (S200).

In an embodiment, in order to specify a vehicle control command capable of being performed by the vehicle 500, the vehicle control system 100 may obtain information about a vehicle and may specify a plurality of vehicle control commands for controlling the vehicle based on the information of the vehicle.

Thereafter, the vehicle control system 100 may perform control so that the menu message is transmitted the account Ac of the vehicle to the account Au of the user. To this end, the vehicle control system 100 may request the IMS providing system 200 to send the menu message (S210). Accordingly, the IMS providing system 200 may send the menu message from the account Ac of the vehicle to the account Au of the user (S220). The menu message transmitted to the account Au of the user may be transmitted to the user terminal 400 and displayed in the messenger application 410 installed on the user terminal 400 (S230, S240).

When the user inputs an instant message corresponding to one of the menus included in the menu message in response to the menu message (S250), the IMS providing system 200 may send the input instant message from the account Au of the user to the account Ac of the vehicle (S260). In response thereto, the vehicle control system 100 may obtain the instant message, transmitted from the account Au of the user to the account Ac of the vehicle, from the IMS providing system 200 (S270).

The vehicle control system 100 may control the vehicle so that the vehicle performs a control operation corresponding to the instant message.

In an embodiment, the vehicle control system 100 may specify a control operation to be performed by the vehicle based on the obtained instant message (S280), and may send a control request for enabling the vehicle 500 to perform the control operation to the telematics server 300 which performs a function for controlling the vehicle 500 (S290).

Accordingly, the telematics server 300 may control the vehicle 500 so that the vehicle performs the control operation (S300). The vehicle 500 may perform the control operation (S310).

The technical spirit of the present invention can provide a method capable of merging various services through a service distribution channel based on SNS/instant messaging/Chatbots and easily updating a new telematics service after the verification of a framework in an existing process of performing vehicle verification for storage update.

Furthermore, a service based on SNS/instant messaging/Chatbots can automate some of the input and request of a user and distribute a service using an explicit request of the user. Accordingly, customer data can be easily collected and customer satisfaction can be improved due to automation through a pattern.

In accordance with the technical spirit of the present invention, there can be provided the system and method for controlling a vehicle based on instant messaging, which enable a user to control his or her vehicle in such a way as to perform messaging with the vehicle through an instant messenger.

The system for controlling a vehicle based on instant messaging according to an embodiment of the present invention can provide a technical spirit, which enables an interaction with a user to be performed and enables the user to control a vehicle through a widely used instant messaging service and messenger application without a need to develop a separate-dedicated application for controlling the vehicle or to install the separate-dedicated application on a user terminal. Accordingly, the vehicle control system has advantages in that it can reduce resources for the development of an application and can handle the addition or change of a vehicle control operation with low cost if the vehicle control operation is added or changed. Furthermore, there is an advantage in that convenience can be improved because a user can control his or her vehicle through the UI of a messenger application that is frequently used by the user.

The vehicle control system 100, IMS providing system 200, telematics server 300, and user terminal 400, may include hardware resources and/or software necessary to implement the technical spirit of the present invention, but does not essentially mean a single physical element or a single device. That is, the vehicle control system 100, IMS providing system 200, telematics server 300, and user terminal 400, may mean a logical combination of hardware and/or software provided to implement the technical spirit of the present invention. In some embodiments, the vehicle control system 100, IMS providing system 200, telematics server 300, and user terminal 400, may be implemented as a set of logical elements disposed in separated devices and configured to implement the technical spirit of the present invention by performing respective functions. Furthermore, the vehicle control system 100, IMS providing system 200, telematics server 300, and user terminal 400, may mean a set of elements separately implemented for each function or role for implementing the technical spirit of the present invention. For example, the account creation module 110, the registration module 120, the acquisition module 130 and/or the control module 140 may be located in different physical devices or may be located in the same physical device. Furthermore, in some implementation examples, pieces of software and/or hardware that form the account creation module 110, the registration module 120, the acquisition module 130 and/or the control module 140, respectively, may be located in different physical devices. Elements located in the different physical devices may be organically combined to realize functions performed by the respective modules.

Furthermore, in this specification, a module may mean a functional or structural combination of hardware for performing the technical spirit of the present invention and software for driving the hardware. For example, a module may mean a logical unit of specific code and hardware resources on which the specific code is to be performed. Those skilled in the art may easily deduce that the module does not essentially mean pieces of code that are physically connected or one kind of hardware.

In some implementation examples, the vehicle control system 100, IMS providing system 200, telematics server 300, and user terminal 400, may include a processor and memory for storing a program executed by the processor. The processor may include a single core CPU or a multi-core CPU. The memory may include high-speed random access memory, and may include one or more magnetic disk storage devices, flash memory devices or non-volatile memory, such as other non-volatile solid state memory devices. Access to the memory by the processor and other elements may be controlled by a memory controller. In this case, when the program is executed by the processor, it may enable the vehicle control system 100 according to the present embodiment to perform the vehicle control method.

The vehicle control method according to an embodiment of the present invention may be implemented in the form of computer-readable program code and may be stored in a computer-readable recording medium. The computer-readable recording medium includes all of kinds of recording devices in which data readable by a computer system is stored.

The program code recorded on the recording medium may have been specifically designed and configured for the present invention or may have been known to and may be used by those skilled in the software field.

Examples of the computer-readable recording medium include magnetic media such as a hard disk, a floppy disk and a magnetic tape, optical media such as CD-ROM and a DVD, magneto-optical media such as a floptical disk, ROM, RAM, and flash memory, and hardware devices specially configured to store and execute program code. Furthermore, the aforementioned medium may be a transmission medium, such as light including a carrier for sending a signal that designates program code, a data structure, etc., a metal line or a waveguide. Furthermore, the computer-readable recording medium may be distributed to computer systems connected over a network, and the computer-readable code may be stored and executed in a distributed manner.

An example of the program code includes not only machine code, such as that produced by a compiler, but also high-level language code executable by a device for electronically processing information using an interpreter, for example, a computer.

The user terminal 400 may be any type of a data processing unit capable of processing calculation or data, receiving and processing input data, processing corresponding information, and outputting the processed results. For example, the user terminal 400 may be a data processing unit, which may be called a general-purpose computer, a personal computer, a server, a portable terminal, a mobile terminal, a remote station, a remote terminal, an access terminal, a terminal, a communication device, a communication apparatus, a communication terminal, a user agent, a user device, a user equipment (UE), a terminal, a notebook, a tablet PC or a smart phone.

The aforementioned hardware device may be configured to operate as one or more software modules in order to perform the operation of the present invention, and vice versa.

The aforementioned description is illustrative, and those skilled in the art to which the present invention pertains will understand that the present invention may be implemented in other detailed forms without departing from the technological spirit or essential characteristics of the present invention.

Accordingly, the aforementioned embodiments should be construed as being only illustrative not as being restrictive from all aspects. For example, each of the elements described in the singular form may be distributed and implemented with multiple devices. Likewise, the elements that have been illustrated as being distributed may also be implemented in a combined form.

The inventive concepts may provide a technical solution which is capable of reducing resources for the development of a dedicated application and handling the addition or change of a vehicle control operation with low cost if the vehicle control operation is added or changed in such a manner that an interaction with a user is performed and a vehicle is controlled through a widely used instant messaging service and messenger application without a need to develop a separate-dedicated application for controlling the vehicle or to install the separate-dedicated application on a user terminal.

Although certain exemplary embodiments and implementations have been described herein, other embodiments and modifications will be apparent from this description. Accordingly, the inventive concepts are not limited to such embodiments, but rather to the broader scope of the presented claims and various obvious modifications and equivalent arrangements.

What is claimed is:

1. A vehicle control method based on instant messaging, the method comprising:
an account creation step of creating, by a vehicle control system based on instant messaging, a vehicle account corresponding to a vehicle of a user in a specific instant messaging service;
a registration step of performing, by the vehicle control system based on instant messaging, control so that the vehicle account is registered with an account of the user previously created in the instant messaging service as a counterpart for conversation;
an acquisition step of obtaining, by the vehicle control system based on instant messaging, an instant message transmitted from the account of the user to the vehicle account through the instant messaging service; and
a control step of performing, by the vehicle control system based on instant messaging, control so that the vehicle performs a control operation corresponding to the instant message.

2. The vehicle control method of claim 1, wherein the acquisition step comprises steps of:
generating a menu message comprising a plurality of menus respectively corresponding to a plurality of vehicle control commands for controlling the vehicle;
performing control so that the menu message is transmitted from the vehicle account to the account of the user; and
obtaining the instant message transmitted from the account of the user to the vehicle account.

3. The vehicle control method of claim 2, wherein the acquisition step further comprises steps of:
obtaining information about the vehicle; and
specifying a plurality of vehicle control commands for controlling the vehicle based on the information of the vehicle.

4. The vehicle control method of claim 2, wherein:
the step of performing control so that the menu message is transmitted from the vehicle account to the account of the user comprises requesting a specific instant messaging service providing system which provides the instant messaging service to send the menu message, and
the step of obtaining the instant message transmitted from the account of the user to the vehicle account comprises receiving the instant message from the instant messaging service providing system.

5. The vehicle control method of claim 1, wherein the control step comprises steps of:
specifying a control operation to be performed by the vehicle based on the obtained instant message; and
controlling the vehicle so that the vehicle performs the specified control operation.

6. The vehicle control method of claim 5, wherein the step of specifying the control operation to be performed by the vehicle based on the obtained instant message comprises specifying the control operation to be performed by the vehicle by performing natural language analysis of the obtained instant message.

7. The vehicle control method of claim 5, wherein the step of controlling the vehicle so that the vehicle performs the specified control operation comprises sending a control request for enabling the vehicle to perform the control operation to a specific telematics server which performs a function for controlling the vehicle.

8. A non-transitory computer-readable medium having stored thereon computer-executable instructions configured to cause a processor to perform the method of claim 1.

9. A vehicle control system based on instant messaging, comprising:
a processor; and
memory configured to store a computer program executed by the processor,
wherein when the computer program is executed by the processor, the computer program enables the vehicle control system based on instant messaging to perform a method according to claim 1.

10. A vehicle control system based on instant messaging, comprising:
a processor configured with processor executable instructions to perform operations for:
an account creation module configured to create a vehicle account corresponding to a vehicle of a user in a specific instant messaging service;
a registration module configured to perform control so that the vehicle account is registered with an account of the user previously created in the instant messaging service as a counterpart for conversation;
an acquisition module configured to obtain an instant message transmitted from the account of the user to the vehicle account through the instant messaging service; and
a control module configured to control the vehicle so that the vehicle performs a control operation corresponding to the instant message.

11. The vehicle control system of claim 10, wherein the acquisition module generates a menu message comprising a plurality of menus respectively corresponding to a plurality of vehicle control commands for controlling the vehicle, performs control so that the menu message is transmitted from the vehicle account to the account of the user, and obtains the instant message transmitted from the account of the user to the vehicle account.

12. The vehicle control system of claim 11, wherein the acquisition module obtains information about the vehicle and specifies a plurality of vehicle control commands for controlling the vehicle based on the information of the vehicle.

13. The vehicle control system of claim 11, wherein the acquisition module requests a specific instant messaging service providing system which provides the instant messaging service to send the menu message in order to perform control so that the menu message is transmitted from the vehicle account to the account of the user, and receives the instant message from the instant messaging service providing system in order to obtain the instant message transmitted from the account of the user to the vehicle account.

14. The vehicle control system of claim 10, wherein the control module specifies a control operation to be performed by the vehicle based on the obtained instant message and performs control so that the vehicle performs the specified control operation.

15. The vehicle control system of claim 14, wherein the control module specifies the control operation to be performed by the vehicle by performing natural language analysis of the obtained instant message in order to specify the control operation to be performed by the vehicle based on the obtained instant message.

16. The vehicle control system of claim 14, wherein the control module sends a control request for enabling the vehicle to perform the control operation to a specific telematics server which performs a function for controlling the vehicle in order to control the vehicle so that the vehicle performs the specified control operation.
